(19) United States
(12) Patent Application Publication
(10) Pub. No.: US 2019/0145080 A1
(43) Pub. Date: May 16, 2019

(54) SYSTEM AND METHOD FOR CONTROLLING MOVEMENT OF MOLDBOARD

(71) Applicant: Caterpillar Paving Products Inc., Brooklyn Park, MN (US)

(72) Inventors: Ryan Steve Hutar, Maple Grove, MN (US); Nathan Louis Mashek, Saint Michael, MN (US); Nicholas Bernard Johnson, Dayton, MN (US)

(73) Assignee: Caterpillar Paving Products Inc., Brooklyn Park, MN (US)

(21) Appl. No.: 15/810,299

(22) Filed: Nov. 13, 2017

(51) Int. Cl. E02F 3/815; A01B 15/10; E02F 3/84; E01C 23/088

(52) U.S. Cl. CPC E02F 3/8155; A01B 15/10; E01C 23/088; E02F 3/8157; E02F 3/84

(57) ABSTRACT

A cold planer is provided. The cold planer includes an engine and an enclosure compartment for a milling rotor. The enclosure compartment includes a frame defining an opening of the enclosure compartment. The enclosure compartment includes a moldboard connected to the frame. The moldboard is configured to move vertically between a first position and a second position with respect to the frame. An interfacing arrangement includes a first pair of components carried by the frame and a second pair of components carried by the moldboard. The components of one of the first pair of components and the second pair of components have slanted edges. The first and second pairs of components are configured to allow a lateral movement of the moldboard when the moldboard is in the first position and to engage one another to prevent the lateral movement of the moldboard when the moldboard is in the second position.

### TECHNICAL FIELD

The present disclosure relates to a cold planer machine, and more specifically, to a system and method for controlling movement of a moldboard of the cold planer machine.

### BACKGROUND

A cold planer machine includes a moldboard. The moldboard is capable of vertical movement between an open and a closed position. During operation, the moldboard needs to be able to move from side to side to a small degree when in a working position. However, this side to side movement of the moldboard is undesired when the moldboard is in the completely lowered or closed position, for example, during travel or when the machine is parked.

U.S. Pat. No. 7,438,364 describes a scraper device for a milling drum mounted in a construction machine. The scraper device includes a scraper blade arranged in a height-adjustable manner behind the milling drum when seen in the direction of travel, which can glide on the surface milled or to be milled by the milling drum, where the scraper blade is guided in lateral guides in a height-adjustable manner relative to the milling drum, and where first centering devices are provided which center the scraper blade between the guides with small lateral play of movement when in a raised position, and which allow a greater lateral play of movement of the scraper blade when the scraper blade is in a lowered working position, it is provided that the second centering devices act upon the upper end of the scraper blade, restricting the lateral displacement of the scraper blade at the upper end in case of a lateral movement of the scraper blade in the guides.

### SUMMARY OF THE DISCLOSURE

In one aspect of the present disclosure, a cold planer is provided. The cold planer includes an engine and an enclosure compartment for a milling rotor. The enclosure compartment includes a frame defining an opening of the enclosure compartment. The enclosure compartment also includes a moldboard connected to the frame. The moldboard is configured to move vertically between an first position and a second position with respect to the frame. An interfacing arrangement includes a first pair of components carried by the frame and a second pair of components carried by the moldboard. The components of one of the first pair of components and the second pair of components have slanted edges. The first and second pairs of components are configured to allow a lateral movement of the moldboard when the moldboard is in the first position and to engage one another to prevent the lateral movement of the moldboard when the moldboard is in the second position.

In another aspect of the present disclosure, an enclosure compartment for a cold planer machine is provided. The enclosure compartment includes a frame defining an opening of the enclosure compartment. The enclosure compartment also includes a moldboard connected to the frame. The moldboard is configured to move vertically between an first position and a second position with respect to the frame. The enclosure compartment also includes an interfacing arrangement including a first pair of components carried by the frame and a second pair of components carried by the moldboard. The components of one of the first pair of components and the second pair of components have slanted edges. The first and second pairs of components are configured to allow a lateral movement of the moldboard when the moldboard is in the first position and to engage one another to prevent the lateral movement of the moldboard when the moldboard is in the second position.

In yet another aspect of the present disclosure, a method for controlling a movement of a moldboard with respect to a frame of a cold planer machine is provided. The method includes providing an interfacing arrangement including a first pair of components carried by the frame and a second pair of components carried by the moldboard. The components of one of the first pair of components and the second pair of components have slanted edges. The method includes operating the moldboard between an first position and a second position. The first and second pairs of components are configured to allow a lateral movement of the moldboard when the moldboard is in the first position. The first and second pairs of components are configured to engage one another to prevent the lateral movement of the moldboard when the moldboard is in the second position.

Other features and aspects of this disclosure will be apparent from the following description and the accompanying drawings.

### BRIEF DESCRIPTION OF THE DRAWINGS

FIG. 1 is a perspective view of an exemplary machine, in accordance with the concepts of the present disclosure;

FIGS. 2 and 3 are front views of one interfacing arrangement provided on a moldboard of the machine of FIG. 1, in accordance with the concepts of the present disclosure;

FIGS. 4 and 5 are front views of another interfacing arrangement provided on the moldboard of the machine of FIG. 1, in accordance with the concepts of the present disclosure;

FIGS. 6 and 7 are front views of yet another interfacing arrangement provided on the moldboard of the machine of FIG. 1, in accordance with the concepts of the present disclosure; and

FIG. 8 is a flowchart of a method for controlling a movement of the moldboard, in accordance with the concepts of the present disclosure.

### DETAILED DESCRIPTION

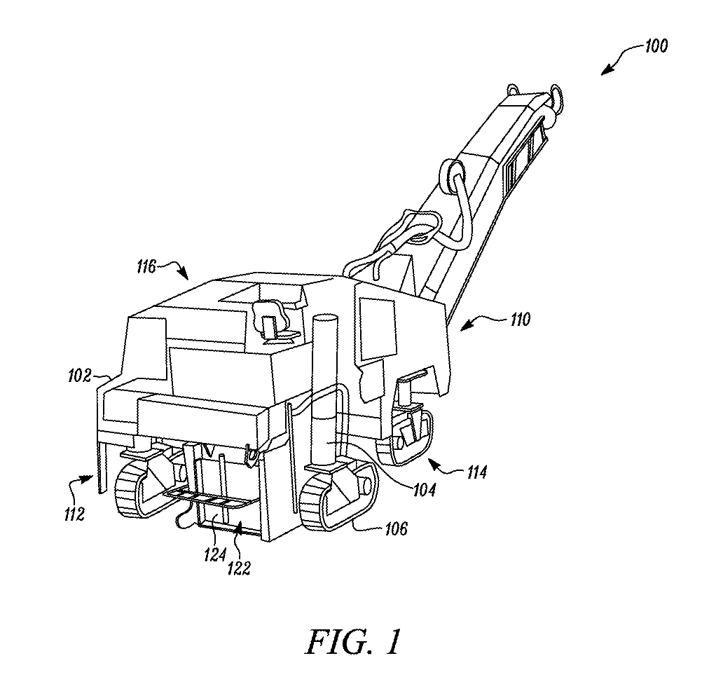

Referring to FIG. 1, an exemplary machine 100 is illustrated. The exemplary machine 100 is a cold planer. The machine is configured to scarify, remove, mix, or reclaim material from the surface of bituminous, concrete, or asphalt roadways and other surfaces. The machine 100 includes a frame 102, support apparatus 104, a plurality of ground engaging units 106, and a tool (not shown). The frame 102 may include a front end 110, a rear end 112, a first side 114 and a second side 116. The support apparatus 112 is configured to support the frame 102 on a surface. The machine 100 has an engine (not shown). Further, the machine 100 includes other components that are not described herein.

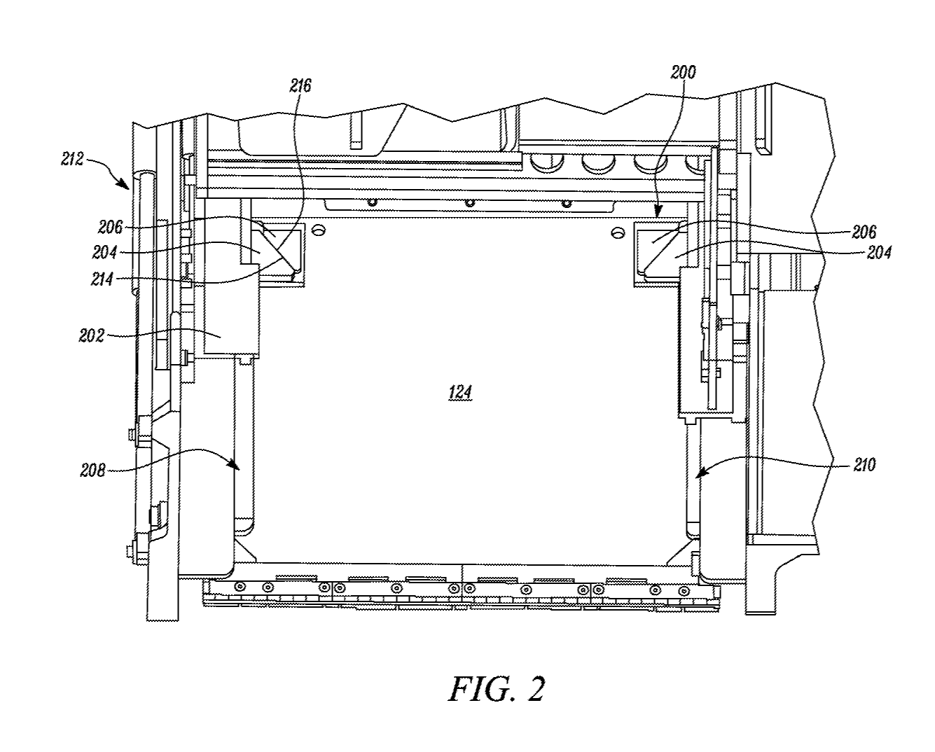

The machine also includes an enclosure compartment 122 for a milling rotor (not shown). The enclosure compartment 122 includes a moldboard 124. The enclosure compartment 124 includes a frame 202 (see FIG. 2). The moldboard 124 is moveable with respect to the frame 202 in a generally vertical direction between an first position and a second position. For the purpose of this disclosure, the moldboard 124 is open or raised when in the first position and the moldboard 124 is closed or lowered when in the second position.

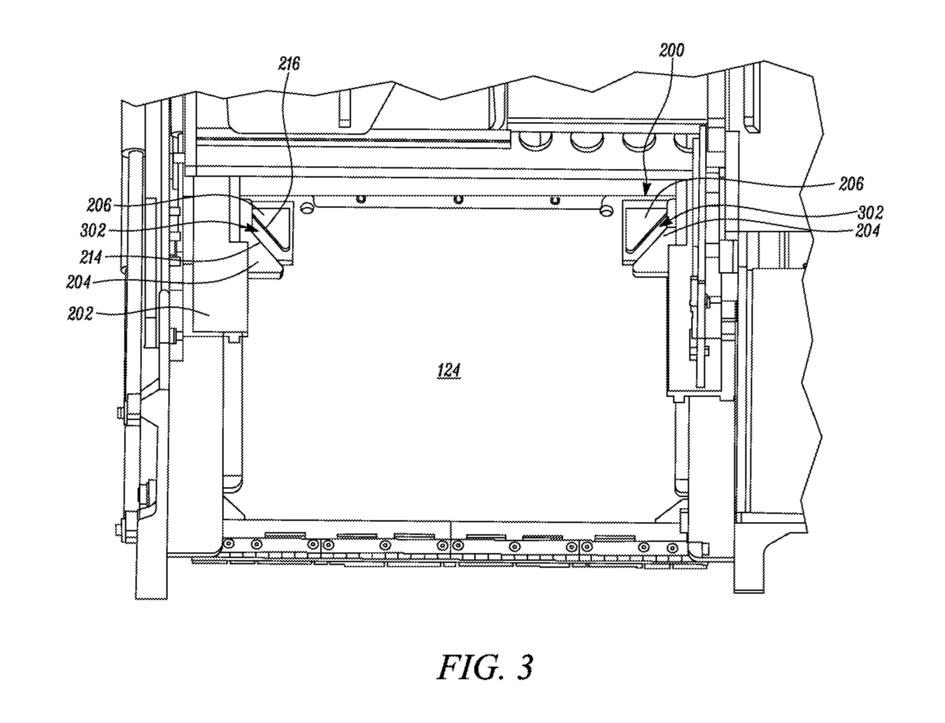

The present disclosure relates to an interfacing arrangement 200 for the moldboard 124. Referring to FIGS. 2 and 3, the interfacing arrangement 200 includes a first pair of components 204 provided on the frame 202. Further, the interfacing arrangement 200 also includes a second pair of components 206 carried on the moldboard 124. As shown, the first and second pair of components 204, 206 are placed on opposing sides 208, 210 of the frame 202. The interfacing arrangement 200 is provided at an upper portion 212 of the moldboard 124 and the frame 202. Alternatively, the interfacing arrangement 200 may be provided at any other suitable location on the moldboard 124 and the frame 202.

Each of the first and second pair of components 204, 206 have a slanted edge 214, 216 respectively. Each of the first and second pair of components 204, 206 have a substantially triangular shape. Referring to FIG. 2, the moldboard 124 is in the second position. In this position, the interfacing components 200 are placed in such a manner that the slanted edges 214 of the first pair of components 204 engage with the slanted edges 216 of the second pair of components 206 to prevent a lateral or sideways movement of the moldboard 124 with respect to the frame 202 when the moldboard 124 is in the second position.

Referring to FIG. 3, the moldboard 124 is shown in the first position. The moldboard 124 may move vertically upwards and downwards with respect to the frame 202 between the second position and the first position. As shown, when the moldboard 124 is in the first position, the first and second pair of components 204, 206 disengage from one another. Additionally, a gap 302 is created between the first and second pair of components 204, 206, allowing the lateral movement of the moldboard 124 relative to the frame 202.

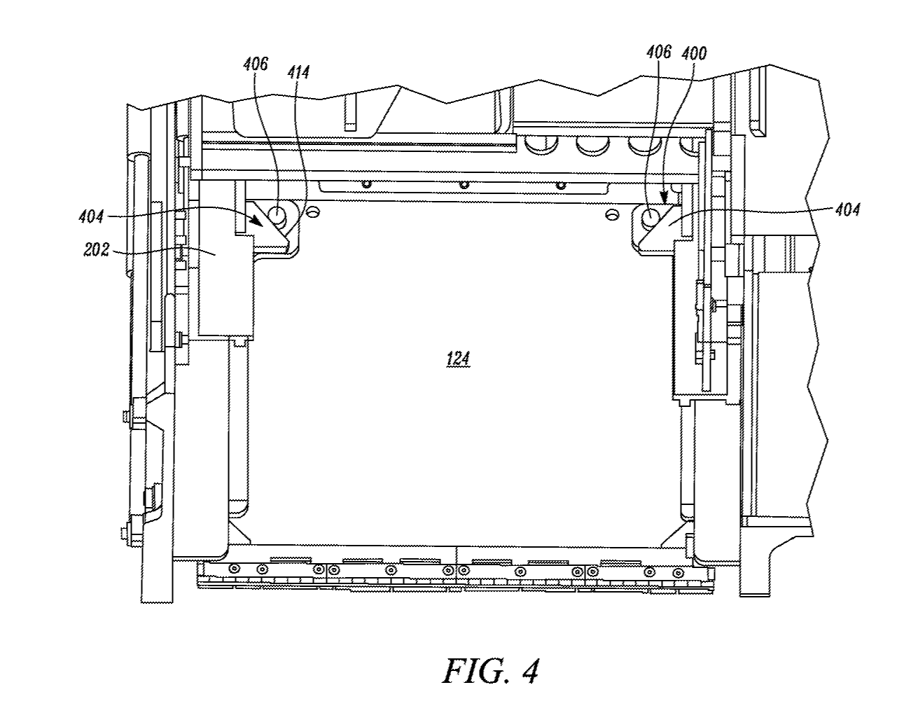

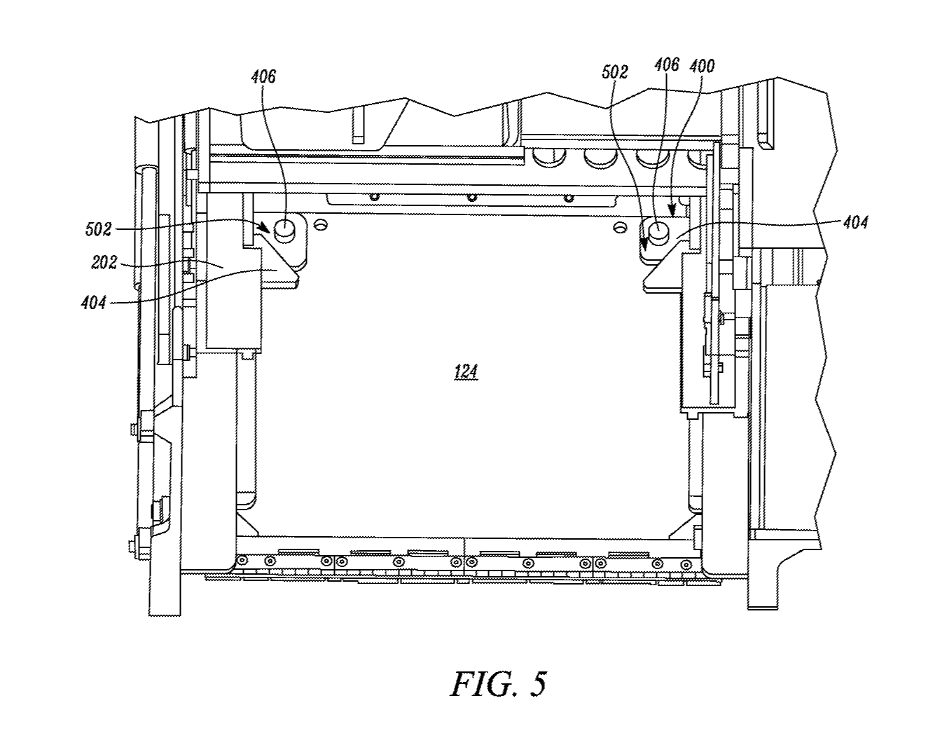

FIGS. 4 and 5 illustrates another interfacing arrangement 400, according to an embodiment of the present disclosure. As described, the first pair of components 404 are provided on the frame 202. The second pair of components 406 are embodied as projections that are circular in shape. When the moldboard 124 is in the second position as in FIG. 4, the circular projection contacts and engages with the slanted edges 414 of the first pair of components 404, preventing the lateral movement of the moldboard 124. As shown in FIG. 5, when the moldboard 124 is in the first position, the gap 502 is created between the first and second pair of components 404, 406 so that the lateral movement of the moldboard 124 can take place. Alternatively, the circular shaped projection may be provided on the frame 202 and the slanted edges 414 may be provided on the moldboard 124.

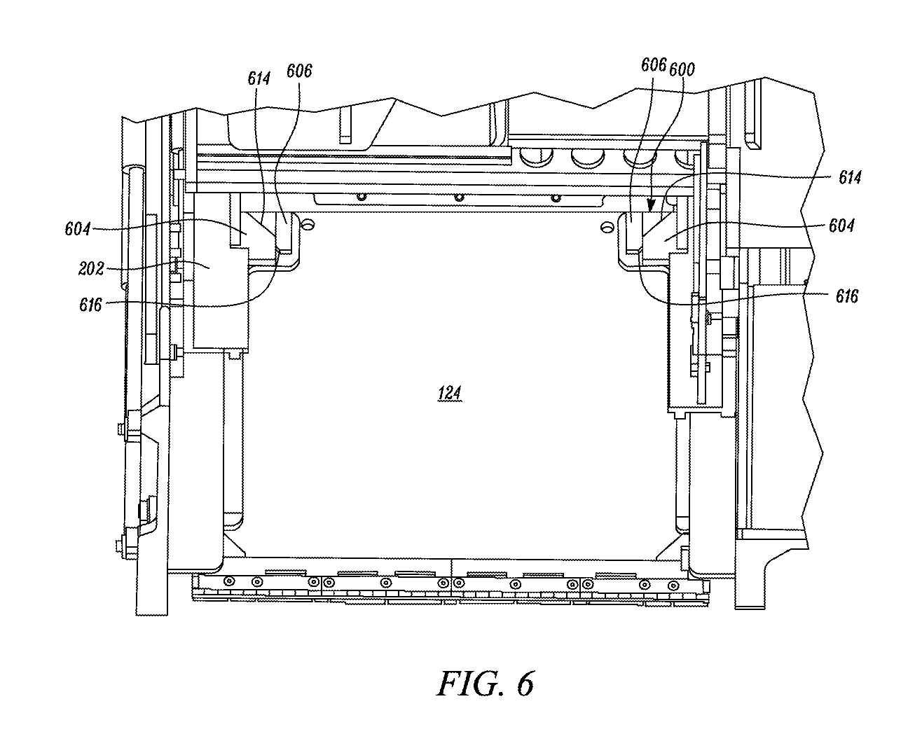

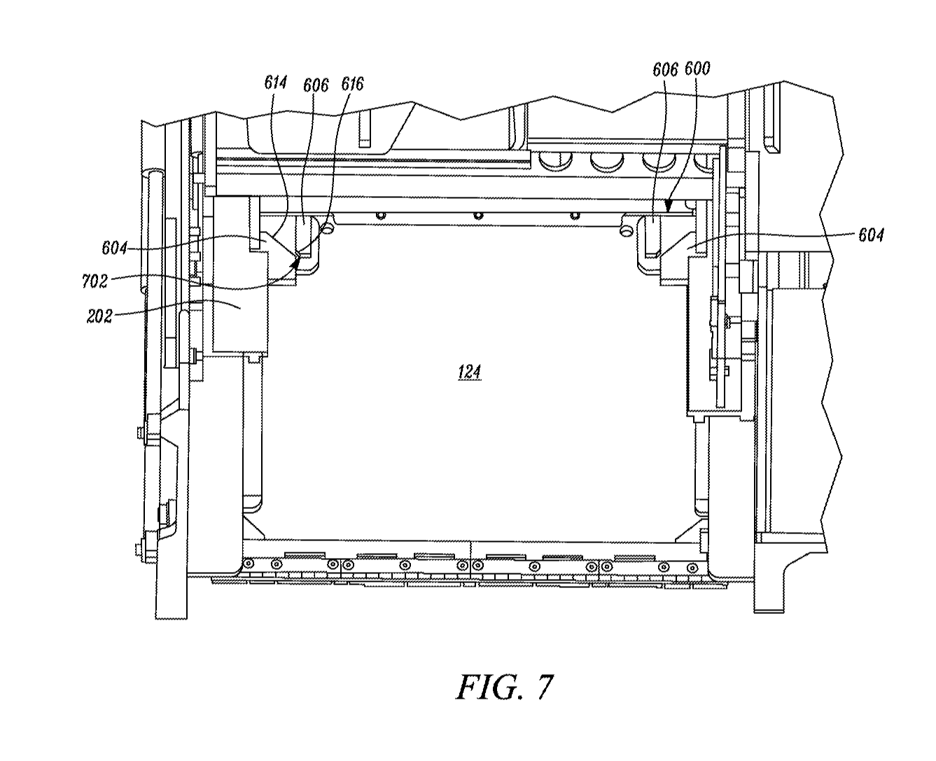

FIGS. 6 and 7 illustrate yet another interfacing arrangement 600, according to one embodiment of the present disclosure. As shown, the first pair of components 604 are provided on the frame 202. The first pair of components 604 have a generally wedge-shaped appearance including the slanted edge 614. The second pair of components 606 are provided on the moldboard 124. The second pair of components 606 have a generally rectangular shape and a corner of the component that faces the first pair of components 604 has a slanted edge 616. When the moldboard 124 is in the second position, the second pair of components 606 engage with the first pair of components 604 for preventing the lateral movement of the moldboard 124. Referring to FIG. 7, when the moldboard 124 is in the first position, the first pair of components 604 disengage from the second pair of components 606. The gap 702 is created between the slanted edges 614, 616 of the first and second components 604, 606 respectively, allowing the lateral movement of the moldboard 124. Alternatively, the rectangular shaped component may be carried by the frame 202 and the wedge-shaped component may be carried by the moldboard 124.

The shape of the first pair of components 204, 404, 604 and the second pair of components 206, 406, 606 provided in the accompanying drawings are exemplary and do not limit the scope of the present disclosure. The first pair of components 204, 404, 604 and the second pair of components 206, 406, 606 may be made of any suitable metal and attached to the frame 202 and the moldboard 124 using known methods. Further, two or more interfacing arrangements 200, 400, 600 may be provided at different locations on the moldboard 124 and the frame 202.

As described above, the first pair of components 404, 604 may include the slanted edge 414, 614. Alternatively, the second pair of components 406, 606 may include the slanted edge. In one example, both the first and second pair of the components 204, 206 include slanted edges 214, 216. The slanted edge of any one or both the first pair of components 204, 404, 604 and the second pair of components 206, 406, 606 selectively interact with one another, such that the lateral movement of the moldboard 124 is allowed when the moldboard 124 is in the first position and is prevented when the moldboard 124 is in the second position. The first pair of components 204, 404, 604 and the second pair of components 206, 406, 606 are shaped and arranged such that the first pair of components 204, 404, 604 and the second pair of components 206, 406, 606 mate with one another for locking the moldboard 124 when in the second position. Also, first pair of components 204, 404, 604 and the second pair of components 206, 406, 606 are disengaged from one another and allow the lateral movement of the moldboard 124 when the moldboard 124 is in the first position.

### INDUSTRIAL APPLICABILITY

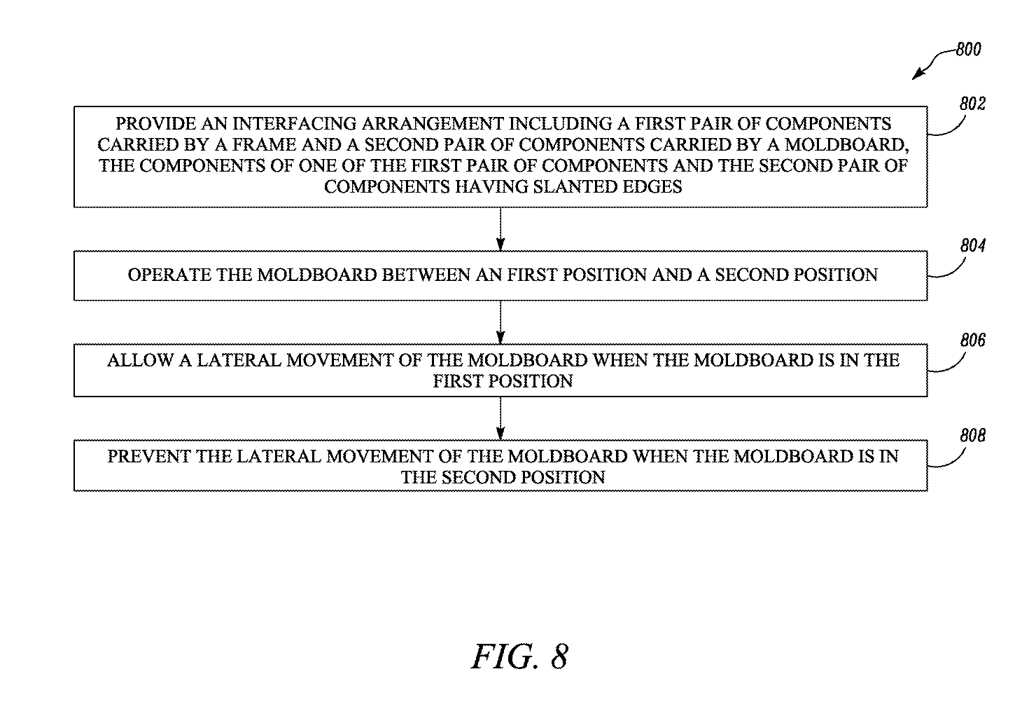

The present disclosure relates to the interfacing arrangement 200, 400, 600 for the moldboard 124 of the machine 100. Referring to FIG. 8, a method 800 for controlling the movement of the moldboard 124 with respect to the frame 202 of the machine 100 is provided. At step 802, the method includes providing the interfacing arrangement 200, 400, 600 including the first pair of components 204, 404, 604 carried by the frame 202 and the second pair of components 206, 406, 606 carried by the moldboard 124. The first pair of components 404, 604 or both the first and second pair of components 204, 206 have respective slanted edges 414, 614 or 214, 216.

At step 804, the method includes operating the moldboard 124 between the first position and the second position. At step 806, the first pair of components 204, 404, 604 and the second pair of components 206, 406, 606 are configured to allow a lateral movement of the moldboard 124 when the moldboard 124 is in the first position. At step 808, the first pair of components 204, 404, 604 and the second pair of components 206, 406, 606 are configured to engage one another to prevent the lateral movement of the moldboard 124 when the moldboard 124 is in the second position.

The interfacing components 200, 400, 600 provide a simple, cost-effective, robust and easy to install solution for controlling the lateral movement of the moldboard 124. The interfacing components 200, 400, 600 allow the lateral movement of the moldboard 124 when the moldboard 124 is in the first position and prevent the lateral movement of the moldboard 124 when the moldboard 124 is in the second position.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A cold planer comprising:
an engine; and
an enclosure compartment for a milling rotor, the enclosure compartment comprising:
a frame defining an opening of the enclosure compartment;
a moldboard connected to the frame, wherein the moldboard is configured to move vertically between a first position and a second position with respect to the frame; and
an interfacing arrangement including a first pair of components carried by the frame and a second pair of components carried by the moldboard, the components of one of the first pair of components and the second pair of components having slanted edges, wherein the first and second pairs of components are configured to allow a lateral movement of the moldboard when the moldboard is in the first position and to engage one another to prevent the lateral movement of the moldboard when the moldboard is in the second position.

2. The cold planer of claim 1, wherein each of the first pair of components and the second pair of components have slanted edges.

3. The cold planar of claim 1, wherein a gap is created between the corresponding first pair and second pair of components when the moldboard is in the first position for allowing the lateral movement of the moldboard.

4. The cold planer of claim 1, wherein the other of the first and second pair components includes a corresponding projection to selectively engage with the corresponding slanted edge.

5. The cold planer of claim 4, wherein the projection has a circular shape.

6. The cold planer of claim 4, wherein the projection has a rectangular shape.

7. The cold planer of claim 1, wherein the interfacing arrangement is provided at an upper portion of the moldboard and distal from an opening edge of the moldboard.

8. The cold planer of claim 1, wherein two or more of the interfacing arrangements are provided on the moldboard and frame respectively.

9. An enclosure compartment for a cold planer machine, the enclosure compartment comprising:
a frame defining an opening of the enclosure compartment;
a moldboard connected to the frame, wherein the moldboard is configured to move vertically between a first position and a second position with respect to the frame; and
an interfacing arrangement including a first pair of components carried by the frame and a second pair of components carried by the moldboard, the components of one of the first pair of components and the second pair of components having slanted edges, wherein the first and second pairs of components are configured to allow a lateral movement of the moldboard when the moldboard is in the first position and to engage one another to prevent the lateral movement of the moldboard when the moldboard is in the second position.

10. The enclosure compartment of claim 9, wherein each of the first pair of components and the second pair of components have slanted edges.

11. The enclosure compartment of claim 9, wherein a gap is created between the corresponding first pair and second pair of components when the moldboard is in the first position for allowing the lateral movement of the moldboard.

12. The enclosure compartment of claim 9, wherein the other of the first and second pair components includes a corresponding projection to selectively engage with the corresponding slanted edge.

13. The enclosure compartment of claim 12, wherein the projection has a circular shape.

14. The enclosure compartment of claim 12, wherein the projection has a rectangular shape.

15. The enclosure compartment of claim 9, wherein the interfacing arrangement is provided at an upper portion of the moldboard and distal from an opening edge of the moldboard.

16. A method for controlling a movement of a moldboard with respect to a frame of a cold planer machine, the method comprising:
providing an interfacing arrangement including a first pair of components carried by the frame and a second pair of components carried by the moldboard, the components of one of the first pair of components and the second pair of components having slanted edges;
operating the moldboard between a first position and a second position,
wherein the first and second pairs of components are configured to allow a lateral movement of the moldboard when the moldboard is in the first position, and
wherein the first and second pairs of components are configured to engage one another to prevent the lateral movement of the moldboard when the moldboard is in the second position.

17. The method of claim 16 further comprising:
creating a gap between the corresponding first pair and second pair of components when the moldboard is in the first position for allowing the lateral movement of the moldboard.

18. The method of claim 16, wherein the other of the first and second pair components includes a corresponding projection to selectively engage with the corresponding slanted edge.

19. The method of claim 18, wherein the projection has a circular shape.

20. The method of claim 18, wherein the projection has a rectangular shape.
